(19) United States
(12) Patent Application Publication
(10) Pub. No.: US 2005/0162034 A1
(43) Pub. Date: Jul. 28, 2005

(54) Soft magnetic composites

(75) Inventor: Zarah Soghomonian, Sterling, VA (US)

Correspondence Address: McDERMOTT, WILL & EMERY, 600 13th Street, N.W., Washington, DC, 20005-3096, US

(73) Assignee: WAVECREST LABORATORIES, INC.

(21) Appl. No.: 10/761,305

(22) Filed: Jan. 22, 2004

(51) Int. Cl. H02K 7/00; H02K 15/00; H02K 11/00

(52) U.S. Cl. 310/216; 310/67 R; 29/596; 310/254

(57) ABSTRACT

Electric motor components, such as a plurality of electromagnetic poles of an annular stator, are formed of soft magnetic composites comprising compacted, electrically isolated iron alloy particles. Embodiments comprise predetermining particular alloy compositions and processing conditions, such as compaction pressures and temperatures, and post compaction heat treating temperatures and atmospheres, for an intended mode of operation, thereby improving manufacturing efficiency and reliability in tailoring soft magnetic composite components for particular design situations.

### FIELD OF THE INVENTION

The present invention relates to soft magnetic composite (SMC) components and to a method of manufacturing soft magnetic composite components. The present invention has particular applicability in manufacturing magnetic components for rotary direct current electric motors.

### BACKGROUND

Direct current motors enjoy a variety of applications. The range of applications becomes even greater with increased availability of advanced battery power sources for DC motors, particularly in articles which require high portability.

Traditional magnetic components for direct current motors have been fabricated from thin laminates of iron-based magnetic materials or sintered composites of magnetic particles. Such conventional methodology yields magnetic components that have traditionally exhibited poor isotropic 2d or 3d electromagnetic properties, because the materials exhibited basically anisotropic properties, particularly in alternating fields and high induction. Such conventionally fabricated materials have also been disadvantageously flaky and brittle, and the magnetic properties structure sensitive.

The concept of a soft magnetic composite has recently evolved. However, its utility to date has been limited, particularly because of the number of variables involved in providing efficient methodology enabling the fabrication of components of a motor targeted for a particular application, such as the ability to tailor the specific properties of soft magnetic composite components which are optimized for a particular motor application.

Accordingly, a need exists for methodology enabling the fabrication of soft magnetic composite components tailored for a particular application with high reliability and repeatability. There exists a particular need for such methodology enabling the fabrication of soft magnetic composites of iron alloys for rotary electric motors.

### DISCLOSURE OF THE INVENTION

The present invention addresses and solves problems attendant upon conventional manufacturing techniques for magnetic components, particularly magnetic components of rotary electric motors, by providing methodology enabling the fabrication of soft magnetic composites of iron alloys tailored for a particular mode of operation. The present invention comprises forming various motor components from soft magnetic materials of an iron alloy, wherein the alloying ingredients and amounts are selected for a particular application, such as for the groups of electromagnetic poles of an annular stator of a rotary electric motor. The present invention also comprises methodology for targeting the shape, dimensions, and properties, i.e., magnetic, electrical and mechanical properties, of a soft magnetic composite component of an electric motor based upon predetermined values.

An advantage of the present invention is a stator comprising groups of electromagnetic poles, each of the groups comprising a soft magnetic composite of compacted individual particles of an iron alloy, each particle coated with a dielectric material such that the particles are electrically isolated from each other. Such soft magnetic composites may be produced by atomizing an iron alloy to form a plurality of individual particles, coating each of the particles with a dielectric coating, forming a mixture of the particles with a lubricant and a binder, compacting the mixture to form a green compact and then heat treating the green compact soft magnetic composite.

Methodology in accordance with embodiments of the present invention includes forming a component of an electric motor, which component comprises a soft magnetic composite having a targeted shape, targeted dimensions and targeted magnetic, electrical and mechanical properties. The method comprises predetermining a magnetic iron alloy composition and predetermining process conditions designed to achieve the targeted properties. The particular magnetic iron alloy is then formulated and comminuted to form a plurality of particles. The particles are coated with a dielectric material, which can be organic or inorganic, i.e., a thin oxide film. The coated iron alloy particles are then mixed with the lubricant and a binder, to form a mixture which is then compacted under predetermined conditions of temperature, pressure, time and atmosphere, to form a green compact. The green compact is then heated under predetermined conditions of temperature, time, and atmosphere to form the soft magnetic composite comprising individual iron alloy particles coated with the dielectric material having the targeted shape, dimensions and properties.

Additional advantages of the present invention will become readily apparent to those skilled in this art from the following detailed description, wherein only the preferred embodiment of the present invention is shown and described, simply by way of illustration of the best mode contemplated for carrying out the invention. As will be realized, the present invention is capable of other and different embodiments, and its several details are capable of modifications and various obvious respects, all without departing from the present invention. Accordingly, the drawings and description are to be regarded as illustrative in nature, and not as restrictive.

### DESCRIPTION OF THE DRAWINGS

The present invention is illustrated by way of example and not by way of limitation in the figures of the accompanying drawing and in which like reference numerals refer to similar elements and in which:

FIG. 1 is a plan diagram of a stator and a rotor layout of a motor in accordance with an embodiment of the present invention.

FIG. 2 is a block diagram illustrating manufacturing steps in accordance with an embodiment of the present invention.

### DETAILED DESCRIPTION OF THE INVENTION

Conventional laminated magnetic components and sintered magnetic components lack the isotropic magnetic requirements and reliability for use in direct current motors, particularly for high torque density application. Soft magnetic composites offer various advantages. The use of powder metallurgical techniques to form soft magnetic composite ensures a wide range of magnetic, electrical and mechanical properties. For example, powder metallurgical techniques enable the formation of complex geometrical designs containing required electromagnetic characteristics which are not dependent upon the shape or the article, i.e., with substantially isotropic properties. Thus, electrical machines may be constructed with complex magnetic paths and three-dimensional magnetic field distribution stemming from the anisotropic nature of soft magnetic composite materials. The magnetic composites also exhibit good dimensional accuracy and stability with smooth surface finishes which is an important factor in the design of excitation coils with significant improvement in the winding factor. Isotropic properties also enable maximizing torque while reducing excess weight, designing streamline magnetic circuitry with optimized magnetic geometries and high torque/net weight ratios with low eddy current losses.

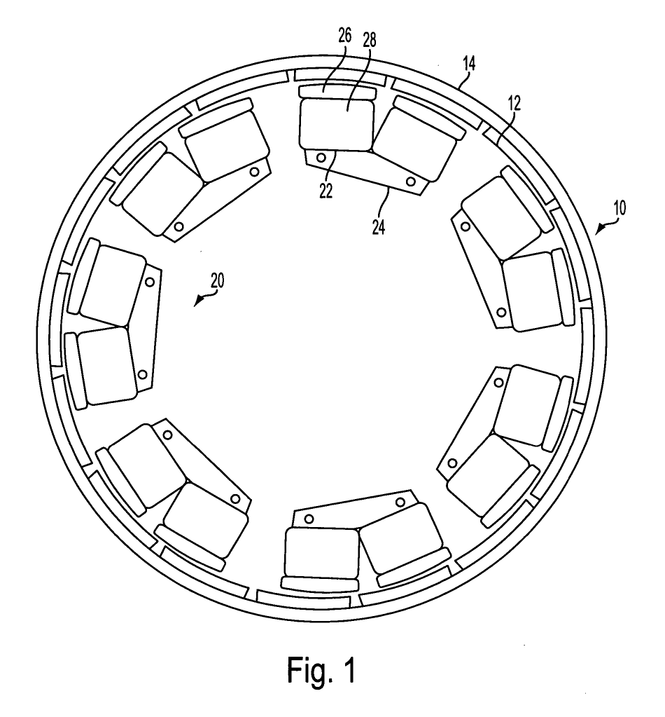

In accordance with embodiments of the present invention, individual complex components of a stator are fabricated using soft magnetic composites, such as the components of the annular stator disclosed in copending application Ser. No. 09/826,422 filed on Apr. 5, 2001 (Attorney Docket No. 57357-015), the entire disclosure of which is hereby incorporated by reference herein. Such a stator is illustrated in FIG. 1 and comprises rotary member 10, which is an annular ring structure comprising a plurality of permanent magnets 12, substantially evenly distributed along cylindrical backplate 14. The permanent magnets are rotor poles that alternate in magnetic plurality along the inner periphery of the annular ring. The backplate comprises magnetically permeable material that serves as a magnetic return path between adjacent permanent magnetic poles 12. The rotor surrounds a stator member 20, the rotor and stator members being separated by a radial air gap. Stator 20 comprises a plurality of elements or groups of pole pairs 22 of uniform construction, e.g., seven elements or groups, that are evenly distributed along the air gap. Each stator group comprises a generally U-shaped magnetic structure 24 having two pole faces 26 at the air gap. Each stator group structure is separate and magnetically isolated from adjacent groups. The legs of the pole pairs are wound with windings 28. The windings of each stator group are connected together so as to be simultaneously activated when connected to a DC source of energization. The windings are configured to provide opposite north/south polarities to the poles of each pole pair, thereby forming an electromagnet. Reversal of polarity of energization effects reversal of the magnetic pluralities of the pole pair. Appropriate timed switching of stator winding energization along the radial air gap effects electromotive force generation through interaction of magnetic forces between the stator and rotor across the air gap.

The rotor permanent magnetic poles are all of uniform angular extent along the air gap and separated from each other by angular gaps of uniform extent. Subject to these uniformity relationships, the actual dimensions of the rotor pole faces and gaps therebetween are variable and can be optimized for a particular application. It should be understood that any even number of rotor poles may be employed, sixteen being depicted in FIG. 1 simply for illustration. The stator pole faces are all of uniform angular extent, preferably of a different dimension than that of the rotor angular pole face.

In accordance with the embodiments of the present invention, individual soft-magnetic composite components are fabricated by formulating a particular magnetic iron alloy, wherein the alloying ingredients and amounts are optimized for a particular application. This enables accurately tailoring a particular soft magnetic composite component for targeted properties, such as magnetic permeability, saturational flux density and eddy current characteristics for stator members. Suitable alloying components include silicon (Si), cobalt (Co), nickel (Ni), phosphorus (P), titanium (Ti), vanadium (V), zirconium (Zr), and aluminum (Al). An example of a suitable alloy composition is as follows:
Si: up to 3.5%
P: 0.3 to 0.8%
C: 0.03% to 0.1%
Cr: 16% to 18%
Mo: 0.5% to 1.5%
Ni: 35% to 80%
Mg: up to 0.8%
V: 0.04% to 0.1%
S: 0.025% to 0.4%
Cr: 7.5% to 18.3%
Mo: 0.2% to 0.5%
Cb: up to 0.25%
Ti: small traces
Fe: Balance

Embodiments of the present invention include fabricating parts, such as an electromagnetic core assembly, comprising 2 or 3 different SMC alloys. By employing plural SMC alloys, various advantages can be realized. For example, plural SMC alloys may be combined in part to aid in heat condition (thermal management), to improve local magnetic properties of the parts, to improve the mechanical/structural properties of part of the assembly, or to embed cooling ducts and pipes as well as sensors or thermoelectric cells. Such plural SMC elements of a single part may comprise different iron alloys and/or the same iron alloy processed in a different manner.

Embodiments of the present invention include strategically adjusting the composition of a soft magnetic composite component to achieve targeted magnetic, electrical, chemical and mechanical properties for a particular application. Application of soft magnetic composite components for electric motors is not limited by that disclosed in FIG. 1. Rather, motor applications include: motors with high efficiency, as for use in motorbikes and automobiles; motors with high permeability as for use with maximum power in a small space, such as in wheelchairs; motors with high speed, which require small high frequency losses, as in generators or torpedoes; motors with low weight, as in aviation applications; and motors with high torque, wherein mechanical properties are significant.

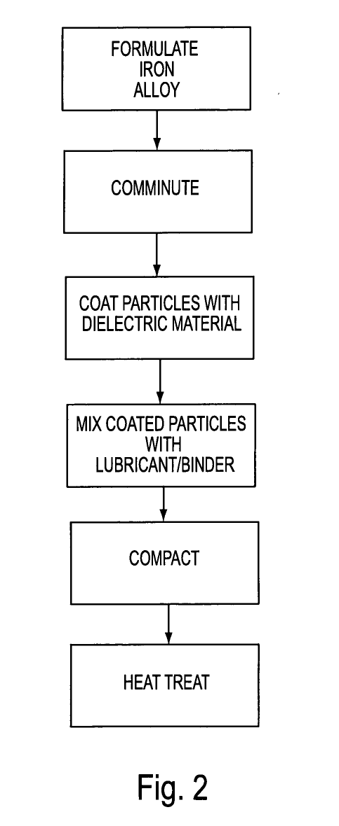

Methodology in accordance with embodiments of the present invention includes implementing any of various powder metallurgical techniques, such as wet compaction, dry compaction, or metal injection molding. As shown in FIG. 2, the initial stage comprises strategically formulating a magnetic iron alloy followed by comminution, as by atomization, to form individual particles of a suitable size, such as a size of about 150 to about 400 micrometers in diameter.

The individual iron alloy particles are encapsulated with a coating of a dielectric material which insulates adjacent particles of powder so as to reduce core losses. Any of various dielectric materials can be employed, such as organic materials, e.g., thermoplastics or thermoset resins. Suitable inorganic materials include iron oxide, iron phosphate, alkali silicates or magnesium oxide. Examples of thermoplastic materials include polyetherimides, polyethersulphones, or polyamideimides.

Suitably, the iron alloy particles are provided with an iron oxide or iron phosphate coating by chemical reaction. An alkali silicate coating may be applied by wetting the powder with a sodium silicate or potassium silicate solution. A coating of magnesium oxide may be applied by thermal conversion of a layer of a magnesium based organometallic compound, or an organomagnesium compound, such as magnesium methylate. Suitably, multiple and/or mixed coatings can be applied. The coating particles are then blended with a lubricant, such as Kenolube™ (available from Hoganas Ab of Sweden). Suitable lubricants include organic, inorganic, and synthetic semi-organic lubricants.

A binder may also be included in the mixture for improved strength, such as an organic binder. Suitable organic binders include phenolic resins. Typically, the lubricant may be added in an amount of about 0.5% by weight, and the binder may also be added in an amount of at least 0.5% by weight. A binder which also functions as a lubricant may also be employed.

The mixture of coated iron alloy particles, lubricant and optional binder is then compacted either at room temperature or at a temperature of about 80° C. to about 200° C., typically at a pressure of about 500 to about 800 Mpa, as at a pressure of about 600-800 Mpa, typically for about 5 to about 30 seconds, to form a green composite. During compaction care is exercised to avoid rupture of the dielectric coating on the individual iron alloy particles, as by experimentally determining the optimum pressure in a particular application.

Subsequently, the green compact is heat treated at a suitable temperature for strengthening and to remove the binder, if present. Such heat treatment can be implemented as a temperature of about 500° C. to about 750° C. in dry purged air, nitrogen or steam atmosphere, typically for about 30 to about 50 minutes. During heat treatment, shrinkage typically occurs depending upon factors, such as the nature and amount of alloying additions.

Soft magnetic components manufactured in accordance with embodiments of the present invention enjoy utility in various different motor applications. Embodiments of the present invention include a protocol to provide efficient methodology enabling the fabrication of the soft magnetic components targeted to various particular applications. In accordance with embodiments of the inventive protocol, certain properties may be targeted. These parameters include:

1. compaction properties, such as force setting, tool design, ejection forces and compaction density;

2. powder properties, such as isotropy, particle size, lubricant ratio and mix ratio;

3. alloying additions, such as Co, Si, Ni, P or combinations thereof;

4. annealing conditions, such as temperature, annealing ramp up, soaking, cool down cycle, annealing atmospheres;

5. magnetic properties, such as core loss, permeability, saturation flux density, coercivity permanent induction, skin effect and magnetostriction;

6. electrical properties, such as resistivity, conductivity and permittivity;

7. mechanical properties such as tensile rupture strength, yield point, crakes and creep;

8. thermal properties, such as coefficient of thermal expansion, emmissivity, thermal conduction and temperature coefficient;

9. additive effective, such as resin binders and lubricants;

10. surface finishes, such as natural oxidation, coating and plating; and

11. particular application, e.g., type of machine component.

In accordance with the inventive protocol, one or more of the above targeted properties, aside from the particular application, are predetermined and an alloy fabricated and processed under conditions to achieve an optimum and uniform density throughout a particular part. The targeted properties are then measured and the alloy reformulated and conditions readjusted until the precise predetermined targeted properties are achieved. The selection of initial parameters and conditions is based upon experience with subsequent adjustments by trial and error. In this way, a set of predetermined alloys and process conditions is obtained for predetermined targeted properties. Thus, a particular application, e.g., automobile motor, wheelchair motor, or aircraft motor, can be selected, the design properties targeted and the inventive method implemented to fabricate soft magnetic components having the desired design properties in an efficient manner.

In an embodiment of the present invention, the dimensions of a green compact are measured before and after post compaction heat treatment to determine the amount of shrinkage during heat treatment. This measured shrinkage is then used as a design parameter in forming green compacts at an appropriate size, with predictable subsequent shrinkage, to obtain predetermined targeted dimensions with high accuracy and repeatability.

### EXAMPLE I

A mixture comprising 0.45 at. % P, 2.0 at. % Si, the balance iron, having a particle size of about 150 to 200 microns was prepared. The powders were then carefully oxidized to provide a dielectric coating encapsulating each particle. The mixture of coated particles was then blended with a 0.5% by volume of lubricant and a organic binder. After blending, the mixture was compacted at a pressure of 600 mPa, at room temperature to obtain a green compact. The green compact was then heated at a temperature of 500° C. in a dry air atmosphere for 40 minutes, undergoing a predetermined shrinkage of 0% percent. The resulting soft magnetic composite component exhibited a density of 7.3 g/cc.

The present invention enables efficient fabrication of soft magnetic composites for electric motor applications with three dimensional flux capability for complex components, flexibility in shaping of complex components, high dimensional accuracy and smooth surfacing, low eddy current losses at higher frequencies, thereby enabling reduced motor size and weight, high tolerances, optimum permeability at the operating flux density level, adequate electrical resistivity, isotropic and high reliability at a reduced cost.

The present invention enjoys industrial utility in the fabrication of any various types of electric motors. The present invention is particularly suitable for rotary electric motors.

In this disclosure there is shown and described only preferred embodiments of the present invention and but a few examples of its versatility. It is to be understood that the present invention is capable of use in various other combinations and environments and is capable of changes and/or modifications within the scope of the inventive process as expressed herein.

1. A stator comprising groups of electromagnetic poles, each of the groups comprising magnetic material magnetically isolated and separated from the other groups, the magnetic material comprising a soft magnetic composite of compacted individual particles of an iron alloy, each particle coated with a dielectric material such that the particles are electrically isolated from each other.

2. A rotary electric motor comprising:
a stator configured in the form an annular ring of groups of electromagnetic poles in accordance with claim 1, the groups substantially equidistantly distributed along the angular extent of the annular ring; and
an annular rotor, concentric with an access of rotation and concentric with the annular stator to form a radial air gap therebetween, comprising a plurality of permanent magnet poles, substantially equidistantly distributed with alternating magnetic polarity along the angular extent of the air gap, the permanent magnetic poles having a common magnetic return path.

3. The rotary electric motor according to claim 2, wherein each group of electromagnetic poles comprises windings that are switchably energized for driving electromotive interaction between the stator and rotor.

4. The stator according to claim 1, wherein the iron alloy comprises at least one element selected from the group consisting of silicon (Si), cobalt (Co), nickel (Ni), phosphorous (P), titanium (Ti), vanadium (V), zirconium, (Zr), and aluminum (Al).

5. The stator according to claim 4, wherein the iron alloy contains 0.0-3 at. % Si and/or 10 to 50 at. % Co.

6. A method of manufacturing a stator comprising groups of electromagnetic poles, each of the groups comprising magnetic material isolated and separated from each other, the method comprising forming the magnetic material of a soft magnetic composite by:
atomizing an iron alloy to form a plurality of particles;
coating each particle with a dielectric material;
forming a mixture of the coated iron alloy particles and a lubricant;
compacting the mixture at an elevated temperature and pressure to form a green compact; and
heat treating the green compact to form the soft magnetic composite.

7. The method according to claim 6, wherein the iron alloy comprises at least one element elected from the group consisting of silicon (Si), cobalt (Co), nickel (Ni), potassium (P), titanium (Ti), vanadium (V), zirconium (Zr), and aluminum (Al).

8. The method according to claim 6, comprising adding a binder to the mixture prior to compacting.

9. The method according to claim 6, comprising forming the soft magnetic composite at a density of at least 98% of the theoretical density for the iron alloy.

10. A method of manufacturing a component of an electric motor, the component comprising a soft magnetic composite having a targeted shape, targeted dimensions and targeted magnetic, electrical and mechanical properties, the method comprising:
determining a magnetic iron alloy composition and process conditions designed to achieve the targeted properties;
forming particles of a predetermined iron alloy composition;
coating each particle with a dielectric material;
mixing the coated iron alloy particles with a lubricant to form a mixture;
compacting the mixture at the predetermined process conditions of temperature, pressure, time and atmosphere to form a green compact; and
heating the green compact at the predetermined conditions of temperature, time and atmosphere to form the soft magnetic composite component comprising the individual iron alloy particles electrically isolated from each other by the dielectric material, the soft magnetic composite component having the targeted shape, dimensions and properties.

11. The method according to claim 10, comprising combining the coated iron alloy particles with a lubricant and a binder to form the mixture.

12. The method of manufacturing a stator comprising a plurality of groups of electromagnetic poles, the method comprising manufacturing the groups of electromagnetic poles from the soft magnetic composite material according to claim 10.

13. A method of manufacturing a rotary electric motor comprising a stator configured in the form of an annular ring of groups of electromagnetic poles, the groups substantially equidistantly distributed along the angular extent of the annular ring, each of the groups comprising magnetic material magnetically isolated and separated from the other groups; and
an annular rotor, concentric with an axis of rotation and concentric with the annular stator to form a radial air gap therebetween, comprising a plurality of permanent magnetic poles substantially equidistantly distributed with alternating magnetic plurality along the angular extent of the air gap, the permanent magnetic poles having a common magnetic return path, the method comprising manufacturing the groups of electromagnetic poles from a soft magnetic composite material formed in accordance with claim 10.

14. A method of manufacturing a rotary electric motor according to claim 13, wherein each group of electromagnetic poles comprises windings that are switchably energized for driving electromotive interaction between the stator and rotor.

15. The method according to claim 10, wherein the iron particles include at least one element selected from the group consisting of silicon (Si), cobalt (Co), nickel (Ni), potassium (P), titanium (Ti), vanadium (V), zirconium (Zr), and aluminum (Al).

16. The method according to claim 10, further comprising:
determining the amount of shrinkage which the green compact undergoes during post compaction heating as a function of the nature and amount of an alloying element of the iron alloy; and
compacting the mixture to a predetermined size such that, upon subsequent heating, the green compact shrinks to achieve the targeted shape and targeted dimensions.

17. A soft magnetic composite produced in accordance with the method according to claim 10.

18. A part comprising at least two different soft magnetic composites, each soft magnetic composite comprising compacted individual particles of an iron alloy, each particle coated with a dielectric material such that the particles are electrically isolated from each other.

19. The part according to claim 18, comprising 3 different soft magnetic composites.

20. The part according to claim 18, wherein each soft magnetic composite comprises a different iron alloy.

21. The part according to claim 18, wherein each soft magnetic composite comprises the same iron alloy.
